(19) United States
(12) Patent Application Publication
(10) Pub. No.: US 2025/0228426 A1
(43) Pub. Date: Jul. 17, 2025

(54) SHOE CLEANING SYSTEM AND METHOD

(71) Applicant: SiFi LLC, Katy, TX (US)

(72) Inventors: Patrick JREIJIRI, Valley Mills, TX (US); Faisal Majid VELANI, Katy, TX (US)

(21) Appl. No.: 19/024,805

(22) Filed: Jan. 16, 2025

Related U.S. Application Data
(60) Provisional application No. 63/621,917, filed on Jan. 17, 2024.

(51) Int. Cl. A47L 23/02; A47L 23/18; A47L 23/28; B08B 3/00

(52) U.S. Cl. CPC A47L 23/02; A47L 23/18; A47L 23/28; B08B 3/00; B08B 2230/01

(57) ABSTRACT

Embodiments of the present disclosure generally relate to methods and devices for cleaning shoes, and more particularly for cleaning and maintaining shoes to extend the lifespan of the shoe by steam cleaning and maintaining the shape with a shoe tree that adjusts to a size of a shoe. The shoe box enclosure includes an exterior structure, one or more shoe trees disposed within an interior of the shoe box enclosure, a water tank disposed on the shoe box enclosure, a water heater disposed on the shoe box enclosure coupled to the water tank, a valve manifold fluidically coupled to the water heater on a first end and a tubing system on a second end. The tubing system is coupled to the one or more shoe trees, a plurality of nozzles, and a front panel tubing system.

### CROSS-REFERENCE TO RELATED APPLICATIONS

This application claims the benefit of U.S. Provisional Application 63/621,917 filed on Jan. 17, 2024, which is incorporated by reference in its entirety.

### BACKGROUND

### Field

Embodiments of the present disclosure generally relate to methods and devices for cleaning shoes, and more particularly for cleaning and maintaining shoes to extend the lifespan of the shoe by steam cleaning and maintaining the shape with a shoe tree that adjusts to a size of a shoe.

### Description of the Related Art

Due to the nature of shoe construction and everyday wear, shoe cleaning and internal support are necessary to maintain shoe structure and prevent damage to a shoe. If not cleaned and maintained, shoes will stain, crease, or lose the structure of their original shape. For these reasons, shoes are often cleaned, and in some cases are cleaned using a steamer. Typical steamer cleaners are hand held devices which moved across the shoe and can lead to uneven steam cleaning of the shoe. In addition, typical shoe trees used for maintaining the shape of shoes are sold for specific shoe sizes and can only maintain shoe structure of that particular shoe size.

Therefore, there is a need for systems and methods that can provide an even steam clean and can include size-adjustable shoe trees to maintain shape and structure of shoes during and after steam cleaning.

### SUMMARY

In a first embodiment, a shoe box enclosure is disclosed. The shoe box enclosure includes an exterior structure including a top side, a base, a first side, a second side, and a back panel, one or more shoe trees disposed within an interior of the shoe box enclosure and removably connected to an interior surface of the shoe box enclosure, one or more doors hingedly connected to one of the top side, the base, the first side, and the second side of the shoe box enclosure, a water tank disposed on the shoe box enclosure, a water heater disposed on the shoe box enclosure and coupled to the water tank, and a valve manifold fluidically coupled to the water heater on a first end and a tubing system on a second end, the tubing system coupled to the one or more shoe trees, a plurality of nozzles, and a front panel tubing system.

In another embodiment, a shoe tree is disclosed. The shoe tree including an adjustable shoe support, an arm, a plurality of openings disposed over at least the arm, and a plurality of steam channels housed within the arm operable to direct a steam through the shoe tree to the plurality of openings.

In another embodiment, a method is disclosed. The method includes positioning one or more shoes over one or more shoe trees having an adjustable shoe support disposed within a shoe box enclosure, adjusting the adjustable shoe support such that it fits to the shoe positioned over the shoe tree; supplying a steam to an interior of the shoe box enclosure through a plurality of openings disposed along the one or more shoe trees, a plurality of nozzles disposed along an interior of the shoe box enclosure, a front panel tubing system disposed in the interior of the shoe box enclosure, or combinations thereof, and cleaning the shoe disposed within the shoe box enclosure.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIGS. 1A, 1B, and 1C are front perspective views of a shoe box enclosure in an open position, according to certain embodiments.

FIGS. 2A and 2B are back perspective views of a shoe box enclosure in an open position, according to certain embodiments.

FIGS. 3A and 3B are perspective views of a pair of shoe trees, according to certain embodiments.

FIGS. 4A and 4B are perspective views of a shoe box enclosure in the closed position, according to certain embodiments.

FIG. 5A is a cross-sectional view showing the internal components of a shoe tree, according to certain embodiments.

FIG. 5B is an exploded view of a shoe tree, according to certain embodiments.

FIG. 6 is a flow chart of a method of use for a shoe box enclosure, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to methods and devices for shoe cleaning, and more particularly for shoe cleaning and maintenance to extend the lifespan of the shoe related to steam cleaning and maintaining the shape with an adjustable shoe tree that can be adjusted to a specific size of a shoe. Shoe maintenance and care are important to extending the life of a pair of shoes. To extend the life of a pair of shoes, the shoes must be efficiently cleaned. One way to clean a pair of shoes is to steam clean the shoes. However, conventional methods of steam cleaning shoes can only clean one side of the shoes at a time and typically fail to uniformly clean the shoes due to uneven treatment of the cleaning process. Further, maintaining the shoe's structural integrity during cleaning is critical to extending the life of the shoes. As disclosed herein, a shoebox enclosure provides support to the shoe's structural integrity during cleaning by providing a shoe tree as well as a controlled environment during cleaning. The shoebox enclosure is operable to clean multiple sides of the shoe as well as the interior of the shoe simultaneously. The combination of the shoe box enclosure and the shoe tree allows for a shoe to be cleaned in a controlled environment while maintaining the shoe shape on the shoe tree.

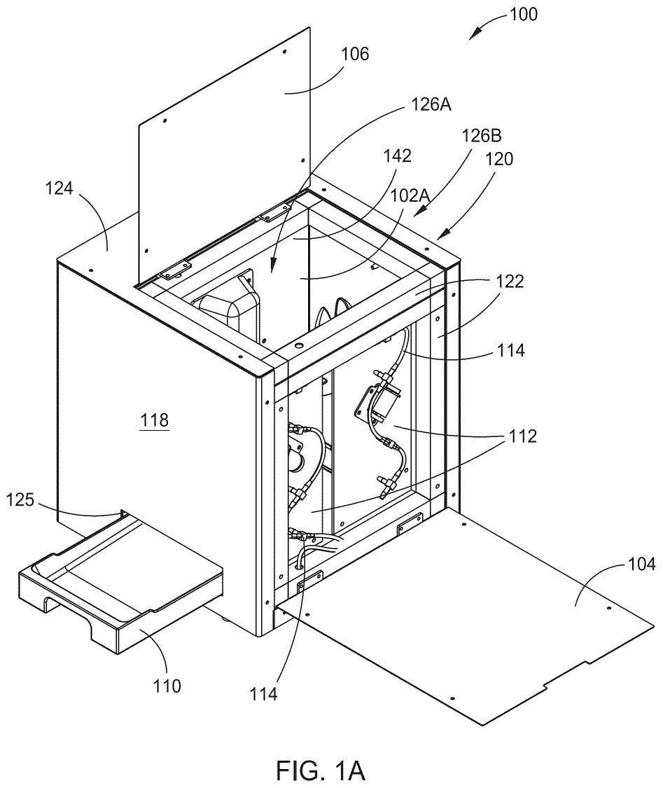

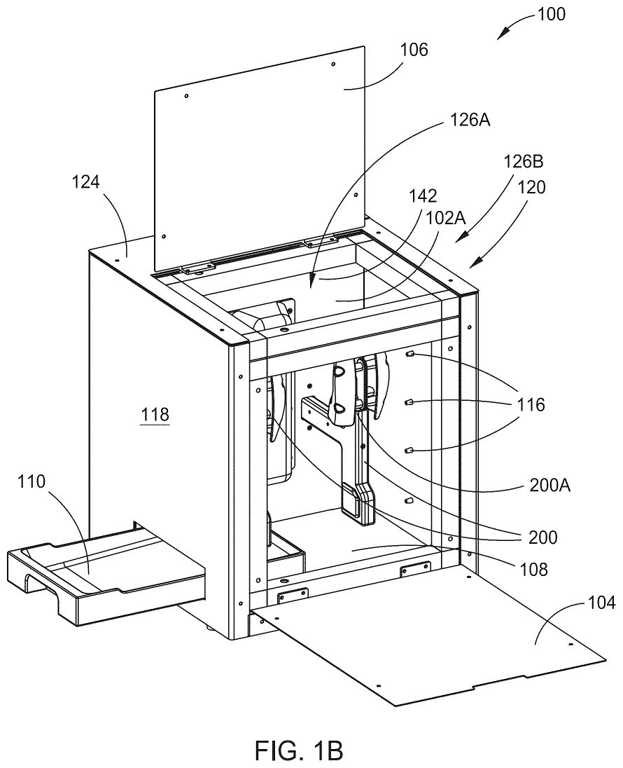

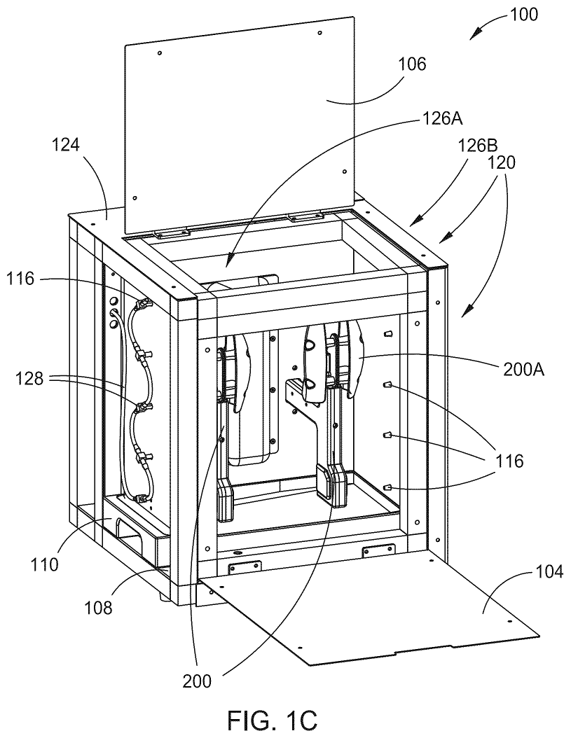

FIGS. 1A, 1B, and 1C are front perspective views of a shoe box enclosure 100 in an open position. The shoe box enclosure 100 further includes an interior 126A and an exterior structure 126B. The exterior structure 126B includes a first door 104, a second door 106, a base 108, a top side 124, a first side 118, a second side 120. In one or more embodiments, the shoe box enclosure 100 includes a switch to control the power supplied to the shoe box enclosure 100 to turn it on or off. The interior 126A of the shoe box enclosure 100 includes an interior back panel 142, a plurality of framings 122, one or more shoe trees 200, a plurality of front panels 112, a tubing system 128, and a plurality of nozzles 116. The tubing system 128 includes a plurality of tubes, which make up at least a plurality of portions of the tubing system 128. Each portion of the tubing system 128 couples to a component of the shoe box enclosure on at least one end such as the valve manifold 140 or the plurality of nozzles 116. In one or more embodiments one or more doors are hingedly connected to one of the top side 124, the base 108, the first side 118, or the second side 120. For example, as shown in FIGS. 1A, 1B, and 1C, the first door 104 is hingedly connected to the base 108 such that the first door 104 opens in a downward direction to allow access to a plurality of front panels 112. For example, as shown in FIGS. 1A, 1B, and 1C the second door 106 is hingedly connected to the top side 124 such that the second door 106 opens in an upward direction to allow access to of the one or more shoe trees 200. As shown in FIGS. 1A, 1B, and 1C two shoe trees are disposed within the shoe box enclosure 100. The plurality of framing 122 extends along the interior 126A of the shoe box enclosure 100 along the first door 104, the first side 118, the second side 120 and the top side 124. In one or more embodiments the plurality of framings 122 provides support to the structure of the shoe box enclosure 100.

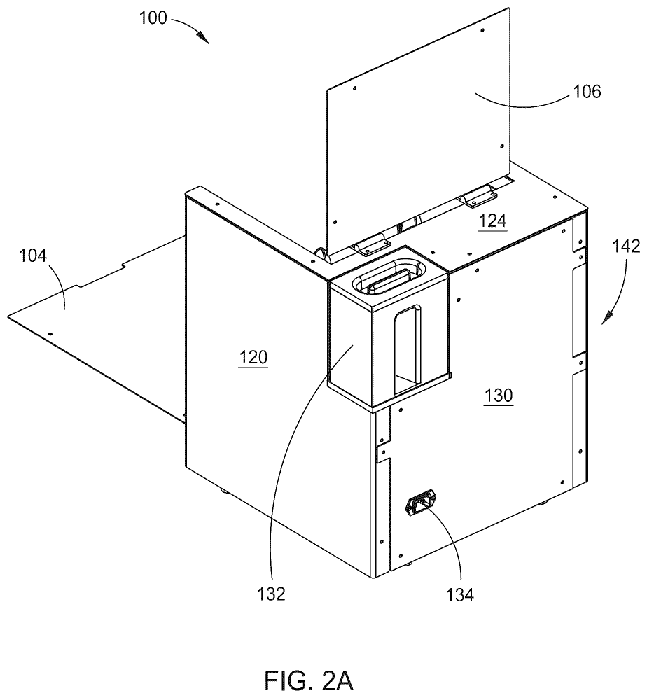

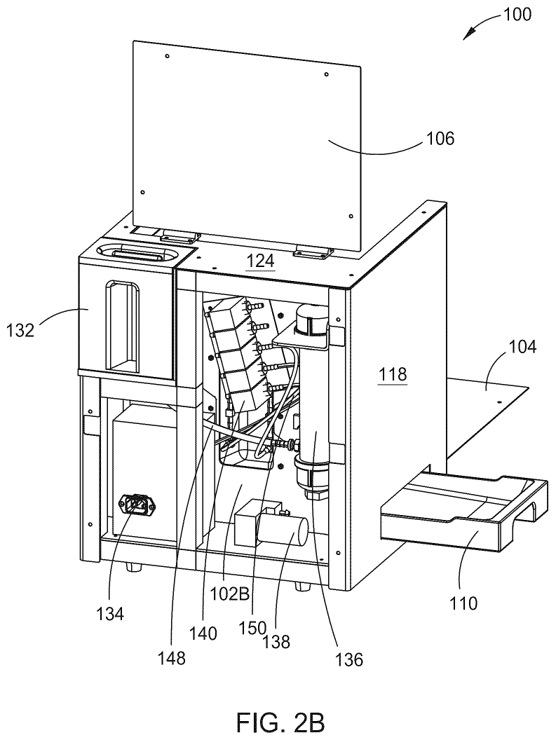

As shown in FIG. 1A, the plurality of front panels 112 are disposed behind the first door 104. The plurality of front panels 112 include a front panel tubing system 114 that provides steam or cleaning solution to the shoes placed on the shoe tree from one direction. The front panel tubing system 114 is coupled to the valve manifold 140 as shown in FIG. 2A. In one or more embodiments, the plurality of front panels 112 are removable. A tray 110 is disposed within the base 108 of the shoe box enclosure 100. As shown in FIG. 1A, the tray 110 is operable to be removed from the base 108 through an opening 125 in the first side 118. The tray 110 is operable to collect residual water or cleaning solution during operation or after operation. The tray 110 is removed from the base 108 through the opening 125 in order to empty the tray 110. In one or more embodiments, the tray 110 is operable to be removed from the base 108 through an opening in the second side 120.

As shown in FIG. 1B, the plurality of front panels 112 are removed and the one or more shoe trees 200 are shown in the shoe box enclosure 100. For example, as shown in FIG. 1B, a pair of shoe trees is shown. In one or more embodiments, the second door 106 provides access to place a shoe on each shoe tree 200A through the top side 124 of the shoe box enclosure 100. The one or more shoe trees 200 are removably connected to an interior surface of the shoe box enclosure 100. For example, as shown in FIG. 1B, the one or more shoe trees 200 are secured to the front side 102A of the interior back panel 142 such that the one or more shoe trees 200 do not contact the base 108, the first side 118, the second side 120, the top side 124, the first door 104 or the second door 106. In one or more embodiments, the one or more shoe trees are secured to base 108, the top side 124, the first side 118, or the second side 120. A plurality of nozzles 116 are disposed within the second side 120. A plurality of nozzles 116 are disposed within the first side 118. The plurality of nozzles 116 are positioned such that the plurality of nozzles 116 provide steam to the interior 126A of the shoe box enclosure 100. The plurality of nozzles 116 disposed within the first side 118 and the second side 120 provide steam to at least one side of the interior 126A of the shoe box enclosure 100 (e.g., each side (e.g., the first side 118 and the second side 120) provides steam in a different direction to the interior 126A of the shoe box enclosure 100).

As shown in FIG. 1C, the plurality of nozzles 116 are coupled to a tubing system 128. The tubing system 128 is coupled on one end to the valve manifold 140 (as shown in FIG. 2B). One portion of the tubing system 128 is disposed within the first side 118. At least one portion of the tubing system 128 provides steam and/or cleaning solution to the plurality of nozzles 116. One portion of the tubing system 128 is disposed within the second side 120. In one or more embodiments the tubing system 128 is coupled to at least the water tank 132 (as shown in FIG. 2B). In one or more embodiments, the tubing system 128 is coupled to the valve manifold 140. In one or more embodiments, the tubing system 128 is coupled to the water heater 136 (as shown in FIG. 2B).

FIGS. 2A and 2B are back perspective views of the shoe box enclosure 100 in an open position. The shoe box enclosure 100 includes a water tank 132, an electrical connection 134, a back panel 130, a water heater 136, a pump 138, water heater tubing 148, a valve manifold 140, valve manifold tubing 150, and a tubing system 128 (shown in FIG. 1C). As shown in FIG. 2A, the back panel 130 covers the interior back panel 142 of the shoe box enclosure 100 (e.g., the back panel 130 is disposed over the back side 102B of the interior back panel 142). The water tank 132 is disposed on the back side 102B of the interior back panel 142. The water tank 132 is operable to store a liquid. For example, the liquid is water, cleaning solution, or combinations thereof. As shown in FIG. 2A an electrical connection 134 is disposed through the back panel 130 of the shoe box enclosure 100. The electrical connection 134 is operable to provide electricity to power the shoe box enclosure 100.

As shown in FIG. 2B, the water tank 132 includes the means to deliver liquid to the pump 138 and/or the water heater 136. For example, the water tank 132 includes at least one valve or port operable to couple to the pump 138 or operable to couple to tubing to direct liquid to the pump 138. In one or more embodiments, the water tank 132 couples to the water heater 136 with a water heater tubing 148. In one or more embodiments, cleaning solution may be added to the water tank 132 in order to provide additional cleaning material to the shoes disposed within the shoe box enclosure 100 during operation. In one or more embodiments, the water tank 132 includes a removable lid such that a user can pour a liquid into the water tank 132. The water heater 136 is operable to heat a liquid to produce a steam. For example, the water heater 136 is operable to heat the water to at least boiling to produce steam. The water heater 136 is coupled to the valve manifold 140 via valve manifold tubing 150 at a first end. The valve manifold 140 is coupled to the tubing system 128 on a second end. In one or more embodiments, the tubing system 128 and the front panel tubing system 114 includes a flexible tubing. In one or more embodiments, the water tank 132 and/or the water heater 136 includes a water level sensor to detect when the water level is low within the water tank 132 or the water heater 136.

In one or more embodiments, an air compressor is attached to a shoe box enclosure 100 to allow compressed air to flow into the shoe box enclosure 100 to remove dust from shoes or dry shoes after a steam clean. In one or more embodiments, an air compressor provides air through the one or more shoe trees 200 through the plurality of steam channels 206. In one or more embodiments, an air compressor provides air through the tubing system 128 to the interior 126A of the shoe box enclosure 100. In another embodiment, a cleaning solution is stored in a separate tank on a shoe box enclosure 100, and the cleaning solution can be added to the water tank 132 via a valve. In another embodiment, a cleaning solution pod is added to the water tank 132.

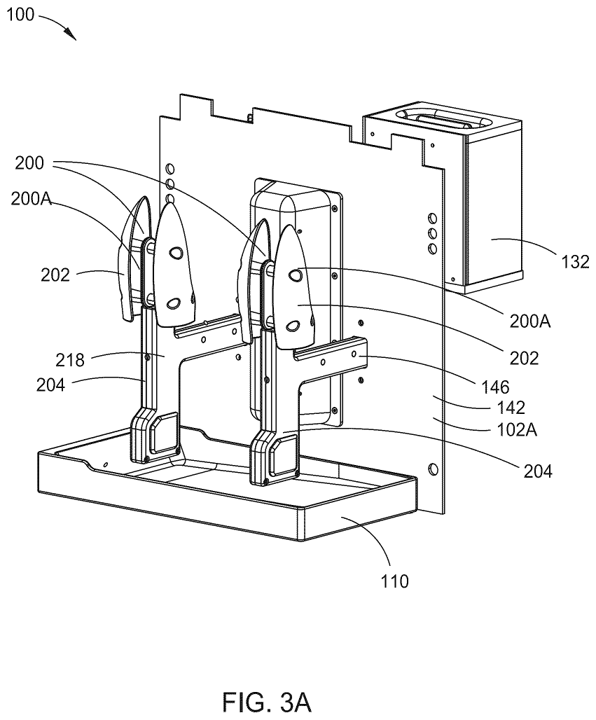

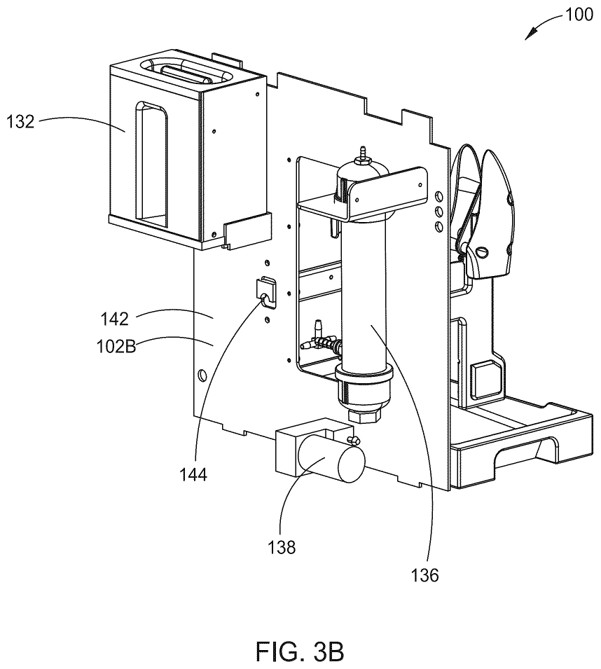

FIGS. 3A and 3B are perspective views of the one or more shoe trees 200. For example, a pair of shoe trees is shown in FIGS. 3A and 3B. Each shoe tree 200A includes an arm 204, an adjustable shoe support 202, at least one bracket 146, and an arm cover 218. Each shoe tree 200A is secured to the interior back panel 142 in the shoe box enclosure 100 with at least one bracket 146. The bracket 144 extends through the interior back panel 142 from the front side 102A to the back side 102B. The interior back panel 142 and the bracket 144 provides support to the pair of shoe trees 200A such that the pair of shoe trees 200A are not contacted by the base 108, tray 110, first side 118, the second side 120, the first door 104, the second door 106, or the plurality of front panels 112. In one or more embodiments, each shoe tree 200A is identical in construction. In one or more embodiments, each shoe tree 200A is a mirror image of the other in construction.

As shown in FIG. 3B, the interior back panel 142 separates the interior 126A (as shown in FIG. 1A) of the shoe box enclosure from at least the water heater 136, the water tank 132 and the pump 138, which are disposed between the interior back panel 142 and the back panel 130. The bracket 144 extends through the interior back panel 142 such that the arm 204 is secured in place.

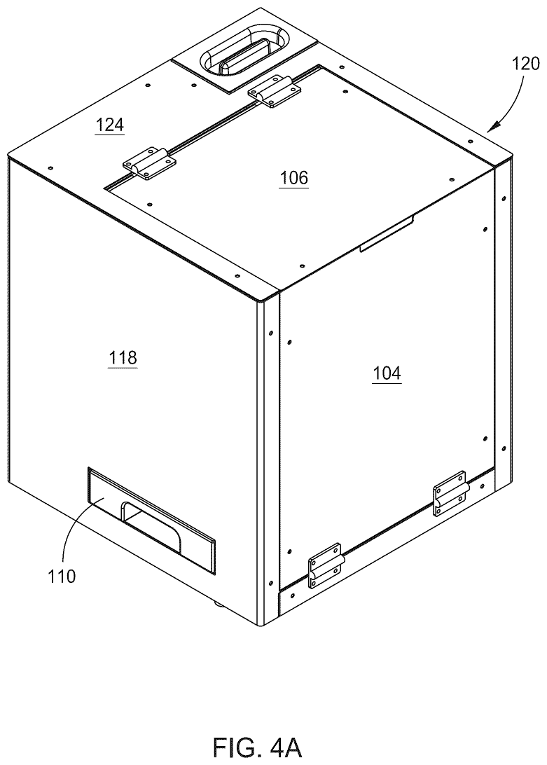

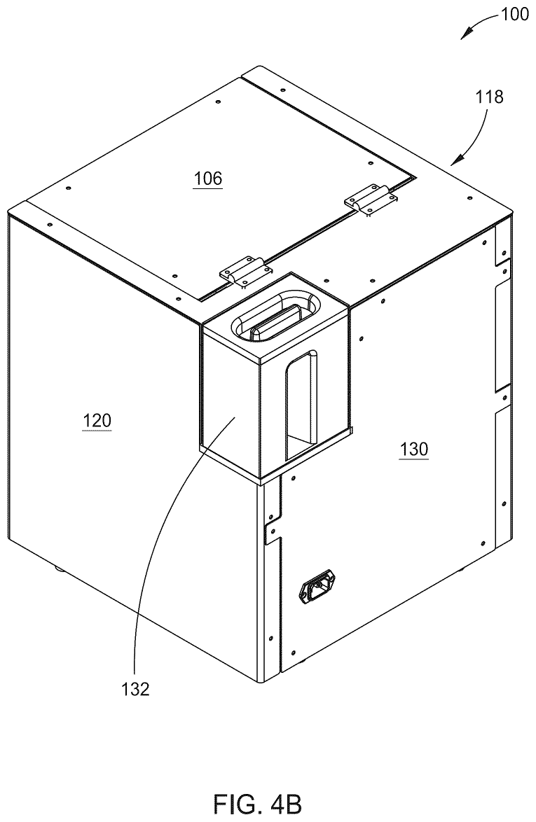

FIGS. 4A and 4B are perspective views of the shoe box enclosure 100 in the closed position. In one or more embodiments, during use, the first door 104 and the second door 106 are closed. In one or more embodiments, when the first door 104 and the second door 106 are closed, steam enters the interior 126A of the shoe box enclosure 100 to clean a pair of shoes and remains within the interior 126A of the shoe box enclosure 100. The steam may condense along the first door 104, the second door, 106, the first side 118, the second side 120, the interior back panel 142, or the top side 124 during use of the shoe box enclosure 100. Any condensation, or any other liquid, within the interior 126A of the falls and is collected in the tray 110. In one or more embodiments, the shoe box enclosure 100 includes a drain.

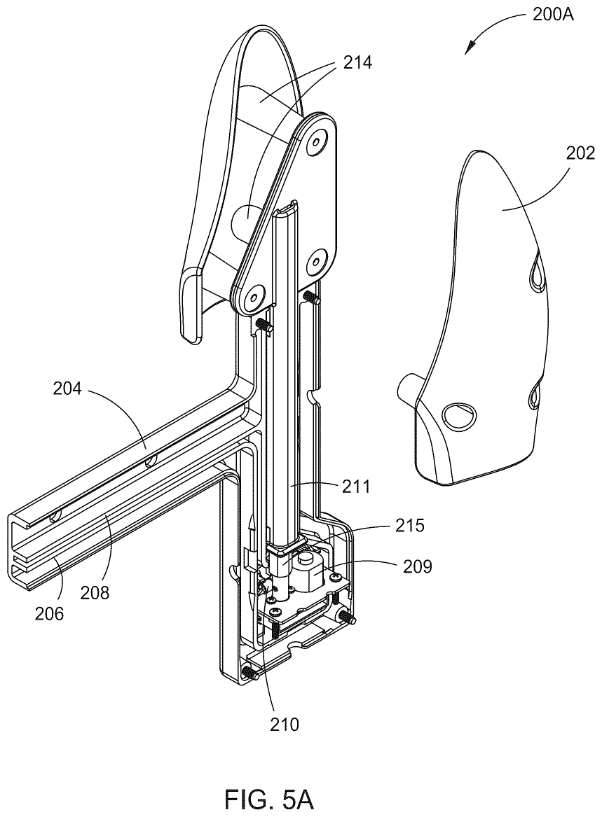

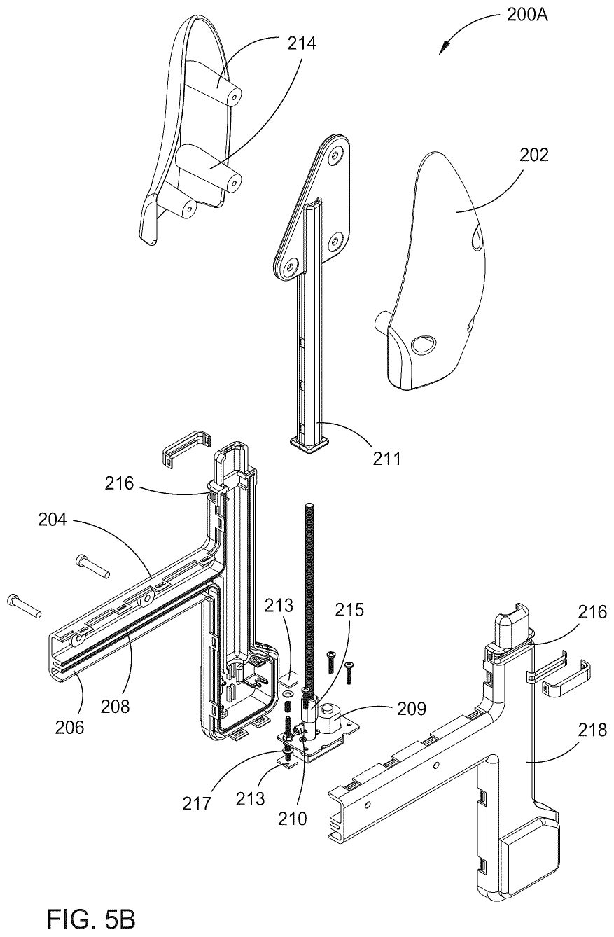

FIG. 5A is a cross-sectional view showing the internal components of a shoe tree 200A. FIG. 5B is an exploded view of a shoe tree 200A. Each shoe tree 200A generally includes an adjustable shoe support 202, an arm 204, and an arm cover 218. Each shoe tree 200A includes internal structures such as a plurality of steam channels 206, at least one electrical channel 208, a microcontroller 210, a motor 209, a slider 211, a plurality of switches 213, a stud 217, a lead screw 215, a plurality of support braces 214, and a plurality of openings 216. The adjustable shoe support 202 is operable to adjust to a size of a shoe that is placed over it. The arm 204 connects the shoe tree 200A to a bracket 144 that connects the shoe tree 200A to the interior back panel 142 such that the bracket extends from the front side 102A of the interior back panel 142 to the back side of the interior back panel 142. Inside the arm 204 the at least one electrical channel 208 houses all necessary wiring to connect the adjustable shoe support 202 and the microcontroller 210 to an electricity source. The at least one electrical channel 208 is insulated such that it protects all electrical components from contacting moisture created by the steam or condensation during method 600.

The plurality of steam channels 206 direct steam through each shoe tree 200A to the plurality of openings 216, which are located on the arm 204. The arm cover 218 is disposed over the internal structures of the arm 204. The steam channels 206 are operable to direct steam through the shoe tree 200A such that the steam exits the shoe tree 200A through the plurality of openings 216. In one or more embodiments, the arm cover 218 forms at least a portion of the at least one electrical channel 208 and the plurality of steam channels 206.

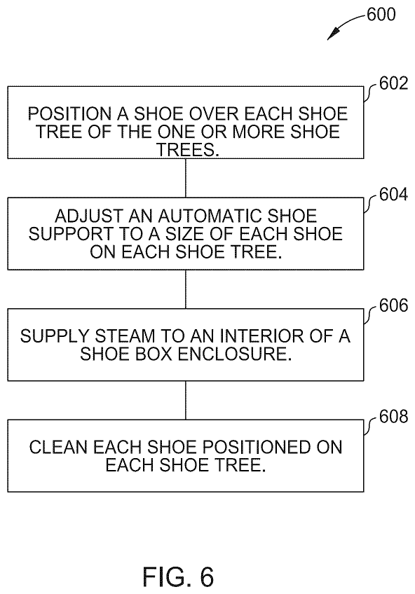

In the method 600 of FIG. 6, the method of use for the shoe box enclosure 100 is disclosed. At operation 602, a shoe (not pictured) is positioned over each shoe tree 200A of the one or more shoe trees 200. As described above and shown in FIG. 1C, the one or more shoe trees 200 are disposed in the interior 126A of the shoe box enclosure 100. In one or more embodiments, the first door 104 is opened to allow access to the pair of shoe trees 200. The one or more shoe trees 200 are positioned in the interior 126A of the shoe box enclosure 100 such that each shoe does not contact the first side 118, the second side 120, the base 108, the top side 124, the first door 104, or the second door 106. The position of each shoe within the interior 126A of the shoe box enclosure 100 allows for an even clean of each shoe.

At operation 604, an adjustable shoe support 202 adjusts to a size of each shoe disposed over each shoe tree 200A. In one or more embodiments, the adjustable shoe support 202 automatically adjusts to the size of the shoe disposed over each shoe tree 200A. In one or more embodiments, the adjustable shoe support 202 is positioned in a home position when not in use. The microcontroller 210 controls a lead screw 215 or any other means of adjusting the size of the adjustable shoe support 202 according to the size of the shoe. The motor 209 drives the lead screw 215 along the slider 211 in order to adjust the size of an adjustable shoe support 202. A plurality of support braces 214 hold the adjustable shoe support 202 together and allow for an adjustment in size. The lead screw 215 and motor 209 are free to slide in a direction of travel. The plurality of switches 213 are activated by a stud 217 when the adjustable shoe support 202 reaches the desired size. The plurality of switches 213 connect to the microcontroller 210 via appropriate electrical connections. The desired size is reached when the lead screw 215 feels resistance against its motion from the shoe that was placed on the adjustable shoe support 202, the lead screw 215 will complete a circuit and stop the sliding motion. The plurality of switches 213 will send a signal that a desired shoe size is met when they are activated by touch by the stud 217 to the microcontroller 210. The completed circuit stops the adjustable shoe support 202 from moving. In one or more embodiments, the adjustable shoe support 202 returns to a home position once the shoe is removed from the shoe tree 200A.

In one or more embodiments, the adjustable shoe support 202 includes a sensor to receive a shoe size input, the adjustable shoe support 202 adjusts according to the shoe size input. Adjusting the adjustable shoe support 202 allows for each shoe disposed over each shoe tree 200A to be securely supported during method 600. The secure support assists in maintaining the structure of each shoe during method 600.

At operation 606, a steam is supplied to the interior 126A of the shoe box enclosure 100. The water tank 132 is operable to hold a liquid such as water, cleaning solution, or combinations thereof. A user fills the water tank 132 with the liquid by removing the lid and adding liquid to the water tank 132. In one or more embodiments, the water tank 132 is coupled to a water source such as a faucet to fill the tank with water. In one or more embodiments, a user adds cleaning solution to the water tank 132 filled with water. The water tank 132 couples to a water heater tubing 148. The water tank 132 includes a port, drain, valve, or any other reasonable means to control the flow of water from the water tank 132 to the water heater tubing 148. The water tank 132 is coupled to the pump 138. The pump 138 controls the flow of liquid from the water tank 132 to the water heater 136. The water heater 136 heats the liquid such that steam is produced (e.g., the liquid is heated to a boiling point). The water heater 136 includes a valve, port, or any other reasonable means to couple the valve manifold tubing 150 to the water heater 136. The valve manifold tubing 150 directs the steam from the water heater 136 to the valve manifold 140. The valve manifold 140 controls the flow of the steam from the water heater 136 to the tubing system 128. The tubing system 128 is coupled to the valve manifold 140. During operation 604, the valve manifold 140 is in a closed position to hold the steam within the valve manifold 140, the valve manifold tubing 150, and/or the water heater 136. In one or more embodiments, the valve manifold 140 is in an open position during method 600.

At operation 606, the steam is supplied to the shoe box enclosure 100. The valve manifold 140 is in an open position to allow steam to flow through the valve manifold 140 and into the tubing system 128. In one or more embodiments, there is a portion of the tubing system 128 extends from the valve manifold to the first side 118 and is disposed within the first side 118. In one or more embodiments, a portion of the tubing system 128 extends from the valve manifold 140 to the second side 120 and is disposed within the second side 120. At least one portion of the tubing system 128 is coupled to the valve manifold 140 at one end and a plurality of nozzles 116 at another end. The plurality of nozzles 116 are disposed in the interior 126A side (e.g., the first side 118 or the second side 120) such that the plurality of nozzles 116 are positioned to provide steam to the interior 126A of the shoe box enclosure (as shown in FIGS. 1B and 1C). In one or more embodiments, the plurality of nozzles 116 are a plurality of openings. Further, the nozzles 116 are spaced along the interior 126A side (e.g., the first side 118 or the second side 120) such that they provide an even amount of steam to the pair of shoes disposed on the plurality of shoe trees 200.

The valve manifold 140 directs steam through the tubing system 128 to the front panel tubing system 114 such that a portion of the tubing system 128 is coupled to the front panel tubing system 114 at a first end. The front panel tubing system 114 is coupled to a plurality of nozzles (similar to the plurality of nozzles 116 disposed along the first side 118 or the second side 120) at a second end. The nozzles coupled to the front panel tubing system 114 are disposed along and through the plurality of front panels 112 such that the nozzles are operable to provide steam to the interior 126A of the shoe box enclosure 100. The plurality of front panels 112 are positioned such that the nozzles provide an even steam clean to the front of the pair of shoes disposed over the pair of shoe trees 200.

The valve manifold 140 directs steam through the tubing system 128 to the one or more shoe trees 200. The one or more shoe trees 200 are coupled to a portion of the tubing system 128 within the arm 204. For example, the tubing system 128 is coupled at a first end to the valve manifold 140 and coupled to the plurality of steam channels 206 disposed within the arm 204 at a second end. The steam from the valve manifold 140 flows through the tubing system 128 and enters the one or more shoe trees 200 and travels through the plurality of steam channels 206 to plurality of openings 216 disposed along the one or more shoe trees 200. The plurality of openings 216 are operable to allow steam to exit each shoe tree 200A and contact an interior of the shoe disposed over the shoe tree 200A. The plurality of openings 216 are spaced such that the steam exits the shoe tree 200A to provide an even clean to the interior of the shoe disposed over the shoe tree 200A.

At operation 608, the pair of shoes disposed over the one or more shoe trees 200 are cleaned. As disclosed above, the tubing system 128, plurality of nozzles 116, front panel tubing system 114, plurality of steam channels 206, and plurality of openings 216 provide steam to the interior 126A of the shoe box enclosure. The steam contacts the pair of shoes disposed over the one or more shoe trees 200 such that it provides an even clean to the exterior and interior of the shoe simultaneously.

Embodiments of the present disclosure generally relate to methods and devices for cleaning shoes, and more particularly for cleaning and maintaining shoes to extend the lifespan of the shoe by steam cleaning and maintaining the shape with a shoe tree that adjusts to a size of a shoe. Using a shoe box enclosure to clean shoes while maintaining the integrity of the shoe shape is important for extending the life of a shoe. The shoe box enclosure allows for an even, gentle, and thorough clean of a shoe.

While the foregoing is directed to embodiments of the present disclosure, other and further embodiments of the disclosure may be devised without departing from the basic scope thereof, and the scope thereof is determined by the claims that follow.

What is claimed is:

1. A shoe box enclosure, comprising:
an exterior structure comprising a top side, a base, a first side, a second side, and a back panel;
one or more shoe trees disposed within an interior of the shoe box enclosure and removably connected to an interior surface of the shoe box enclosure;
one or more doors hingedly connected to one of the top side, the base, the first side, and the second side of the shoe box enclosure;
a water tank disposed on the shoe box enclosure;
a water heater disposed on the shoe box enclosure and coupled to the water tank; and
a valve manifold fluidically coupled to the water heater on a first end and a tubing system on a second end, the tubing system coupled to the one or more shoe trees, a plurality of nozzles, and a front panel tubing system.

2. The shoe box enclosure of claim 1, wherein the one or more shoe trees further comprise an automatic shoe support, an arm, and a plurality of steam channels.

3. The shoe box enclosure of claim 1, wherein the one or more shoe trees further comprise at least one electrical channel, a microcontroller, plurality of support braces, a motor, a slider, a plurality of switches, a lead screw, a stud, and a plurality of openings.

4. The shoe box enclosure of claim 1, wherein the water heater is operable to heat a liquid to form a steam, the steam is directed into the shoe box enclosure through the valve manifold and the tubing system, and the steam is provided to one or more shoe trees, the plurality of nozzles, the front panel tubing system, or a combination thereof such that the steam contacts an inside of a shoe disposed on the one or more shoe trees and an outside of the shoe disposed on the one or more shoe trees.

5. The shoe box enclosure of claim 1, wherein the water tank is operable to hold water, a cleaning solution, or combinations thereof.

6. The shoe box enclosure of claim 1, wherein the water heater is operable to heat water, a cleaning solution, or combinations thereof to form a steam.

7. The shoe box enclosure of claim 1, wherein a portion of the tubing system is disposed within the first side and a portion of the tubing system is disposed within the second side.

8. The shoe box enclosure of claim 1, further comprising a tray disposed within the base, wherein the tray is removable from the base.

9. A shoe tree comprising:
an adjustable shoe support;
an arm;
a plurality of openings disposed over at least the arm; and
a plurality of steam channels housed within the arm operable to direct a steam through the shoe tree to the plurality of openings.

10. The shoe tree of claim 9, further comprising at least one electrical channel housed within the arm such that the electrical channel is separated from the plurality of steam channels.

11. The shoe tree of claim 9, wherein the plurality of openings are operable to direct steam out of the shoe tree.

12. The shoe tree of claim 9, further comprising a microcontroller, plurality of support braces such that the plurality of support braces are disposed within the adjustable shoe support to provide shoe support.

13. The shoe tree of claim 9, further comprising a motor, a slider, a plurality of switches, a lead screw, and a stud wherein the motor, the slider, the plurality of switches, the lead screw, and the stud are operable to control a movement of the adjustable shoe support.

14. A method comprising:
positioning one or more shoes over one or more shoe trees having an adjustable shoe support disposed within a shoe box enclosure;
adjusting the adjustable shoe support such that it fits to the shoe positioned over the shoe tree;
supplying a steam to an interior of the shoe box enclosure through a plurality of openings disposed along the one or more shoe trees, a plurality of nozzles disposed along an interior of the shoe box enclosure, a front panel tubing system disposed in the interior of the shoe box enclosure, or combinations thereof; and
cleaning the shoe disposed within the shoe box enclosure.

15. The method of claim 14, further comprising adjusting the adjustable shoe support via a microcontroller, a lead screw, and a motor, wherein the microcontroller controls the motor and lead screw and the lead screw extends or retracts the one or more shoe trees until the lead screw is met with resistance or returns to a home position.

16. The method of claim 14, wherein supplying the steam to the interior of the shoe box enclosure further comprises:
heating a liquid to form steam;
directing the steam into the shoe box enclosure through a tubing system; and
providing steam to the one or more shoe trees, a plurality of nozzles, a front panel tubing system or combination thereof.

17. The method of claim 16, wherein the tubing system couples to a plurality of steam channels disposed within an arm of each one or more shoe trees such that steam is directed through the tubing system to the plurality of steam channels.

18. The method of claim 17, wherein the plurality of steam channels are coupled to a plurality of openings such that the steam exits each of the one or more shoe trees through the plurality of openings and contacts an interior of the one or more shoes disposed over each of the one or more shoe trees.

19. The method of claim 16, wherein the tubing system couples to the plurality of nozzles, the front panel tubing system, or combinations thereof, wherein the plurality of nozzles is disposed within a first side of the shoe box enclosure, a second side of the shoe box enclosure, or combinations thereof such that the plurality of nozzles and the front panel tubing direct steam to the interior of the shoe box enclosure.

20. The method of claim 14, wherein the steam contacts an interior of the one or more shoes disposed over each of the one or more shoe trees and an exterior of the one or more shoes disposed over each of the one or more shoe trees.
